(19) United States
(12) Patent Application Publication
(10) Pub. No.: US 2014/0337471 A1
(43) Pub. Date: Nov. 13, 2014

(54) MIGRATION ASSIST SYSTEM AND MIGRATION ASSIST METHOD

(71) Applicant: HITACHI, LTD., TOKYO (JP)

(72) Inventors: Yoshiko YASUDA, Tokyo (JP); Yosuke HIMURA, Tokyo (JP); Yoji OZAWA, Tokyo (JP)

(73) Assignee: HITACHI, LTD., TOKYO (JP)

(21) Appl. No.: 14/273,937

(22) Filed: May 9, 2014

(30) Foreign Application Priority Data
May 10, 2013 (JP) 2013-100578

(51) Int. Cl. H04L 29/08

(52) U.S. Cl. CPC H04L 67/02
USPC 709/217

(57) ABSTRACT

A system for assisting migration between first and second information processing systems includes a table retaining communication information on communication between first nodes constituting the first information processing system; a table retaining a design requirement being a condition for a second node constituting the second information processing system; an identifier configured to identify the communication information on the first node which is to be migrated; a comparator configured to acquire the design requirement associated with the identified communication information; a mapper configured to determine based on the design requirement whether addition or deletion of the second node is necessary or not; and a generator configured to generate tenant design properties based on the determination on whether addition or deletion is necessary or not, the tenant design properties being information necessary for the migration and containing a configuration of the second node constituting the second information processing system.

### CROSS-REFERENCE TO RELATED APPLICATION

The present application claims the benefit of priority pursuant to 35 U.S.C. §119(a) to Japanese Patent Application No. 2013-100578, filed on May 10, 2013, the entire disclosure of which is hereby incorporated herein by reference.

### BACKGROUND

1. Technical Field

The present invention relates to a migration assist system and a migration assist method.

2. Related Art

In recent years, application of cloud computing (or a cloud) to a data center (DC) has been advancing. Generally, in a cloud, a DC provider constructs multiple company systems or business systems for intra use by using virtualization technology on an information processing system including servers, storage devices, and networks. Being based on the virtualization technology, the cloud is more scalable than a physical system. Meanwhile, the cloud where multiple information processing systems are incorporated into a single information processing system is complicated due to the coexistence of the multiple information processing systems (multitenancy). A virtualized information processing system or a virtualized business system for each client, which is incorporated into the cloud, is called a tenant.

With the advance of the cloud computing, a service of migrating the entire or part of an existing information processing system to a tenant of the cloud has been emerging. The existing information processing systems include an intra-use company system used only inside a company, a system hosted by a data center or the like, a tenant constructed on a cloud (a multitenant information processing system) provided by a data center provider, and the like.

Conventionally, to migrate an existing information processing system constructed inside a company, to migrate a tenant constructed on a cloud to another cloud as a new tenant, or to migrate a tenant constructed on a cloud to an intra-use company system, an administrator of a migration source information processing system (cloud user) needs to create tenant design information for the migration target cloud. The tenant design information is design information necessary for construction of the information processing system, and is more abstract than setting information dependent on a group of devices constituting a tenant.

However, since an existing information processing system and a cloud, or a certain cloud and another cloud have different design policies for system non-functional requirements, such as security requirements, performance requirements, and reliability requirements, it is difficult to create tenant design information according to the requirements of the migration target. For example, the cloud user can know non-functional parameters of the existing information processing system, but it is difficult for the cloud user to know the tenant design policies of the cloud. To be more specific, the cloud user can know the type of a network service (e.g., SQL or HTTP) used between multiple servers being constituents (nodes) of the existing information processing system, as well as performance parameters set for communication between the servers (such as, e.g., a timeout value). However, the cloud user is not able to know the design policies of the migration target cloud (e.g., security designs determining a criterion for using a firewall and other criteria, performance designs indicating the degree of communication delay expected in the migration target cloud, or reliability designs such as redundancy), and it is therefore difficult for the cloud user to determine how to map the existing information processing system to a tenant on the migration target cloud.

As a result, it is hard for the cloud user to speedily create tenant design information having configuration modifications when migrating an existing information processing system of a migration source to a tenant on the cloud.

As background arts of this technical field, there are the following inventions regarding inter-cloud migration.

First, there is Japanese Patent Application Publication No. 2011-186637 (PTL 1). PTL 1 discloses a resource cooperation system and a resource cooperation method by which a service executed on a certain cloud can be provided by using resources of another cloud (paragraph 0005). In addition, there is Japanese Patent Application Publication No. 2011-129117 (PTL 2). PTL 2 discloses a technique by which a cloud federator locates an appropriate cloud for providing a service or data sought by a cloud client, among interoperable multiple incompatible clouds (paragraph 0023). Moreover, there is Japanese Patent Application Publication No. 2012-84129 (PTL 3). PTL 3 discloses that by fixing the structure of virtual private data centers abstractly, all of the configuration and service data can be transferred to another site and can be repositioned at the new site (paragraph 0009).

Although PTL 1 discloses a resource cooperation system by which a service executed on a certain cloud can be provided by using resources of another cloud, only a virtual server is targeted for migration, and this system is based on the assumption that the configuration of the virtual server does not change between the migration source and the migration target.

PTL 2 discloses a technique by which a cloud federator locates, among incompatible clouds, an appropriate cloud for providing a service or data sought by a cloud client, but fails to disclose how to map the service or data between the incompatible clouds.

PTL 3 states that by fixing the structure of virtual private data centers abstractly, all of the configuration and service data can be repositioned at another site, but this technique is unable to create an abstract structure based on non-functional parameters of a migration source, and is made on the assumption that the migration source and a migration target have the same abstract parameters.

The present invention has been made in view of the above points, and has an objective of providing a migration assist system and a migration assist method capable of readily migrating an existing information processing system to a migration target information processing system having different design requirements from those of the existing information processing system.

### SUMMARY

A main aspect of the present invention for solving the above problems is a system for assisting migration from a first information processing system to a second information processing system, the migration assist system comprising: a communication information management table retaining communication information on communication between first nodes constituting the first information processing system; a design requirement management table retaining a design requirement being a condition for a second node constituting the second information processing system; an identifier configured to identify, in the communication information management table, the communication information on the first node which is to be migrated; a comparator configured to acquire the design requirement associated with the identified communication information from the design requirement management table; a mapper configured to determine based on the design requirement whether addition or deletion of the second node is necessary or not; and a generator configured to generate tenant design properties based on the determination on whether addition or deletion is necessary or not, the tenant design properties being information necessary for the migration and containing a configuration of the second node constituting the second information processing system.

Another aspect of the present invention is a method for an information processing apparatus to assist migration from a first information processing system to a second information processing system, the information processing apparatus including a communication information management table retaining communication information on communication between first nodes constituting the first information processing system, and a design requirement management table retaining a design requirement being a condition for second node constituting the second information processing system, the method comprising the steps, executed by the information processing apparatus, of: identifying, in the communication information management table, the communication information on the first node which is to be migrated; acquiring the design requirement associated with the identified communication information from the design requirement management table; determining based on the design requirement whether addition or deletion of the second node is necessary or not; and generating tenant design properties based on the determination on whether addition or deletion is necessary or not, the tenant design properties being information necessary for the migration and containing a configuration of the second node constituting the second information processing system.

According to the present invention, an existing information processing system can be readily migrated to an information processing system having different design requirements from those of the existing information processing system.

### BRIEF DESCRIPTION OF DRAWINGS

FIG. 1 is a diagram showing a system configuration according to an embodiment of the present invention;

FIG. 2 is a configuration example of a system property management table;

FIG. 3 is a configuration example of a node property management table;

FIG. 4 is a configuration example of a communication property management table;

FIG. 5 is a configuration example of a cluster management table;

FIG. 6 is a configuration example of a migration target node management table;

FIG. 7 is a configuration example of a security requirement table;

FIG. 8 is a configuration example of a performance requirement table;

FIG. 9 is a configuration example of an availability requirement table;

FIG. 10 is a configuration example of a node configuration modification rule management table;

FIG. 11 is a diagram showing an overall flow of tenant design management processing;

FIG. 12 is an image example of a viewer for using a tenant design management device;

FIG. 13 is a diagram showing a flow of tenant design property generation processing;

FIG. 14A is a diagram showing an image of system properties; and

FIG. 14B is a diagram showing an image of tenant design properties.

### DETAILED DESCRIPTION

Using the drawings, a migration assist system according to one embodiment of the present invention is described below.

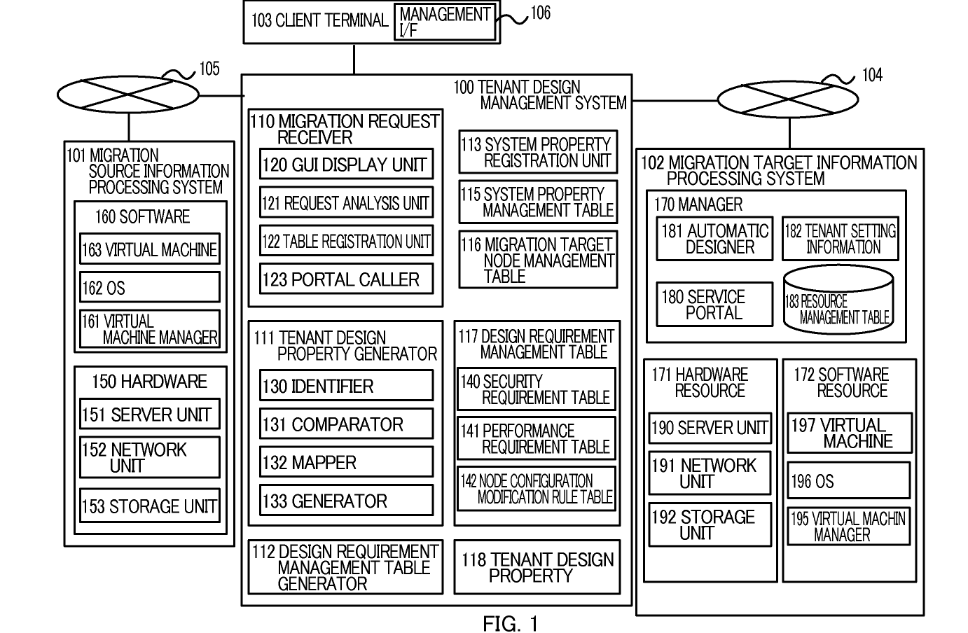

FIG. 1 is a diagram showing an example of the overall configuration of the migration assist system according to the embodiment.

The migration assist system of the embodiment is a system configured to assist migration from a migration source information processing system 101 to a migration target information processing system 102, and is configured by including a tenant design management system 100, the migration source information processing system 101, the migration target information processing system 102, a client terminal 103, a network 104, and a network 105. The migration assist system of the embodiment can be used in cases such as where programs or data are to be migrated from the migration source information processing system 101 (an intracompany system) to the migration target information processing system 102 (a cloud) so that an information processing service operated as an intracompany system of a client may be operated on a cloud as an information processing service virtualized for the client (such information processing service is called a “tenant” hereinbelow).

The client terminal 103 is a computer manipulated by a user performing migration work. The client terminal 103 includes a management interface (I/F) 106 via which the user can access the tenant design management system 100.

The tenant design management system 100 generates design information necessary for migration from the migration source information processing system 101 to the migration target information processing system 102 (the design information is called “tenant design properties” hereinbelow). The migration source information processing system 101 may be an intracompany system constructed in a company or a tenant on a cloud provided by a data center or the like. The migration target information processing system 102 may be a tenant constructed on a cloud or an intracompany system constructed in a company. They may be any combination of these. Moreover, all the constituents (called “nodes” hereinbelow) of the migration source information processing system 101 may be targeted for the migration, or only some of the nodes may be targeted for the migration. The tenant design management system 100 is an information processing apparatus including a CPU, a memory, and a storage device such as a hard disk. The tenant design management system 100 implements various functions, which will be described later, by reading programs recorded in a recording medium onto the memory and executing them.

The migration source information processing system 101 includes hardware 150 and software 160. The hardware 150 includes a server unit 151, a network unit 152, and a storage unit 153. The server unit 151 is constituted by one or more physical servers. The physical servers constituting the server unit 151 are each a computer which includes a CPU, a memory, and a storage device and implements the software 160 when the CPU reads programs stored in the storage device onto the memory and executes them. The network unit 152 couples each server of the server unit 151 to another server thereof or to the storage unit 153. The network unit 152 includes various types of network devices, e.g., communication device such as a switch, security device such as a firewall, communication channels constructed by an Ethernet (registered trademark), radio communication channels, public telephone lines, and mobile phone lines, and the like. The embodiment assumes that the network unit 152 performs communication in accordance with TCP/IP, but the protocol of communication performed by the network unit 152 is not limited to this. The storage unit 153 is a storage device configured to store data. The storage unit 153 may have multiple storage devices connected by a storage area network (SAN) or may have one or multiple storage devices connected to the physical server.

The software 160 includes a virtual machine manager 161, an operating system (OS) 162, and a virtual machine 163. The software 160 is installed for each physical server of the server unit 151. When the physical server is not virtualized, the virtual machine manager 161 is not included. A business application is installed in the virtual machine 163.

The migration target information processing system 102 includes a manager 170, a hardware resource 171, and a software resource 172. The hardware resource 171 includes a server unit 190, a network unit 191, and a storage unit 192. The server unit 190 is constituted by one or more physical servers. Like the network unit 152 of the migration source information processing system 101, the network unit 191 includes various types of network devices, security devices, communication channels, and the like. The software resource 172 includes a virtual machine manager 195, an OS 196, and a virtual machine 197. The software resource 172 is installed for each physical server of the server unit 190, and the virtual machine manager 195 is not included when the physical server is not virtualized.

The manager 170 includes a service portal 180, an automatic designer 181, tenant setting information 182, and a resource management table 183.

The service portal 180 receives a tenant configuration request from outside and calls the automatic designer 181 to perform design processing.

The tenant setting information 182 is setting information on hardware resources necessary for constructing a tenant, and is generated by the automatic designer 181.

The resource management table 183 is for managing the usage statuses of the hardware resource 171 and the software resource 172, and in response to a request to use resources from the automatic designer 181, reserves available resources and returns information on those resources.

The automatic designer 181 generates the tenant setting information 182 based on tenant design properties contained in a tenant configuration request received via the service portal 180 and based on resource usage information held by the resource management table 183, and sets the tenant setting information 182 to setting target devices. Processing performed by the automatic designer 181 can be implemented using a technique described in, for example, Japanese Patent Application Publication No. 2012-253550.

The tenant design management system 100 includes a migration request receiver 110, a tenant design property generator 111, a system property registration unit 113, a system property management table 115, a migration target node management table 116, a design requirement management table 117, and a tenant design property management table 118. The tenant design management system 100 implements the migration request receiver 110, the tenant design property generator 111, and the system property registration unit 113 by reading programs recorded in a recording medium onto a memory and executing the programs. The system property management table 115, the migration target node management table 116, the design requirement management table 117, and the tenant design property management table 118 are implemented as part of a storage area provided by the memory and the storage device of the tenant design management system 100. The system property management table 115, the migration target node management table 116, the design requirement management table 117, and the tenant design property management table 118 may be managed by one or some of the migration source information processing system 101, the migration target information processing system 102, and other information processing apparatuses, and tenant design management system 100 may access the system managing the tables.

The system property management table 115 is for managing information on (properties of) nodes of the migration source information processing system 101 and properties regarding communications between the nodes. There are several types of nodes, including e.g. a server node, a switch node, and a security node such as a firewall. For example, the node properties include properties regarding hardware, such as a CPU, a memory, a disk size, and the number of network interfaces, and properties regarding software, such as an OS installed in the hardware, the type of virtualization software, and settings of a business application. For example, settings of the OS and business application also include performance parameters such as a timeout value for communication and the number of simultaneous accesses allowed (called “performance properties” hereinbelow). The contents of the properties of a node differ depending on the type of the node, and the present invention is not limited to the items described herein. The “system properties” are a group of pieces of setting information necessary for construction of an information processing system, and is more abstract than setting commands for devices. However, the system properties are assumed herein to be so-called design policies (rules) according to which an information processing system can be set up.

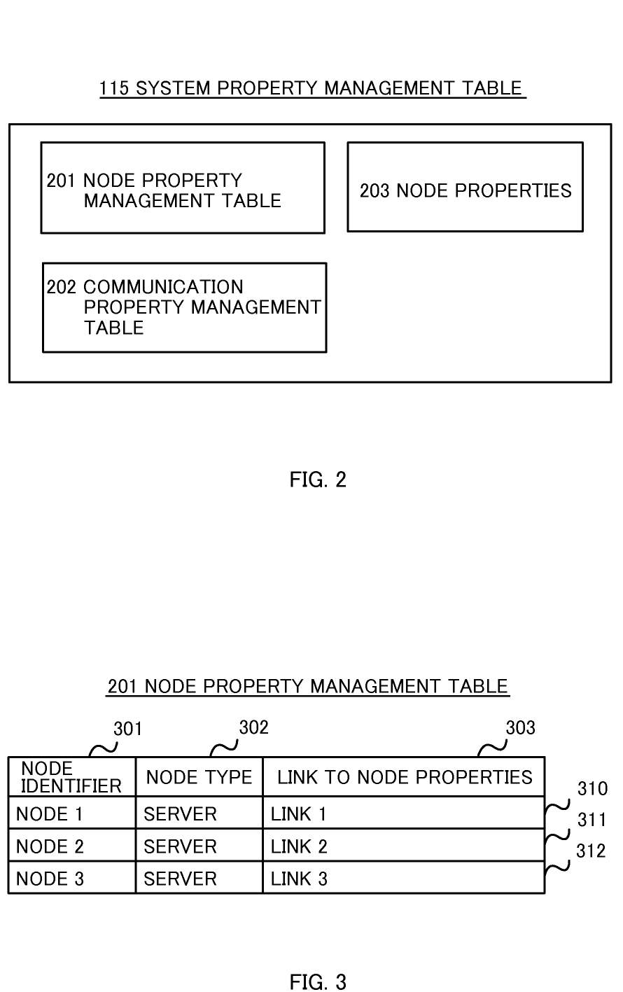

FIG. 2 is a diagram showing a configuration example of the system property management table 115. The system property management table 115 contains a node property management table 201 managing properties regarding nodes of the migration source information processing system 101 (called “node properties” hereinbelow), a communication property management table 202 managing properties regarding communications between the nodes (called “communication properties” hereinbelow), and node properties 203 storing entities of the node properties. The system property management table 115 is created by the system property registration unit 113 to be described later in response to a migration request from the client terminal 103, and is referred to by the tenant design property generator 111 to be described later.

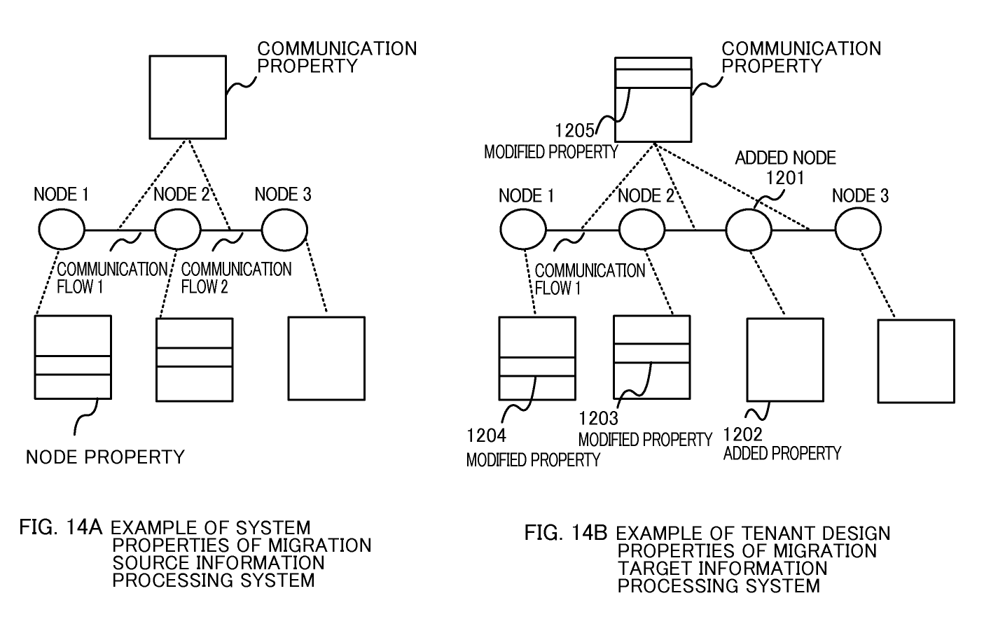

FIG. 14A illustrates system properties of the migration source information processing system 101 managed by the system property management table 115. The migration source information processing system 101 is formed by one or more nodes (1 to 3) and communication flows (1 and 2) for interconnecting the nodes. Node properties are registered for each of the nodes (1 to 3).

FIG. 3 is a diagram showing a configuration example of the node property management table 201.

The node property management table 201 is for managing a list of nodes constituting the migration source information processing system 101. A node type 302 and a link to node properties 305 are stored in association with a node identifier 301 being node identification information. The node type 302 indicates, for example, whether the node is a server node, a storage node, or a security node. The link 305 indicates the node properties 203 associated with the node indicated by the node identifier 301.

The node properties 203 include, in a case of a server node for example, CPU performance, memory size, the number of network interfaces, the type of virtualization software operating on the server node, an OS, an application, setting parameters for them, and the like. In a case of a storage node, the node properties 203 also include disk capacity. In a case of a security node, the node properties 203 include a network policy. Other types of nodes also include various parameters necessary for construction of a node in an information processing system. The node properties 203 further include performance properties as parameters regarding performance. The performance properties include a timeout value for communication delay. Moreover, the performance properties may include the number of maximum connections and the like, but are not limited to these, and may include various other parameters regarding node performance. For example, when the system has a cluster configuration, the node properties 203 may include properties regarding availability. The node properties 203 are created in response to a migration request.

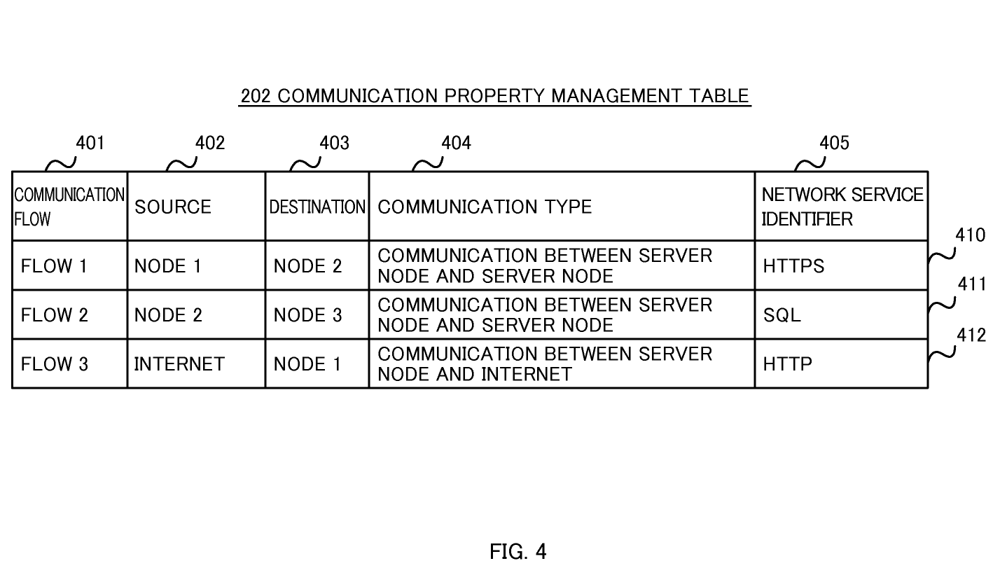

FIG. 4 is a diagram showing a configuration example of the communication property management table 202. The communication property management table 202 is for managing communication properties of the migration source information processing system 101. The communication property management table 202 is created in response to a migration request, and is referred to by the tenant design property generator 111.

The communication property management table 202 stores, in association with a communication flow identifier 401 for identifying communication between nodes (called a “communication flow” hereinbelow), a source 402, a destination 403, a communication type 404, and a network service identifier 405. The communication type 404 is information indicating the type of communication performed by the corresponding communication flow. The communication type 404 includes, for example, “communication between server node and server node” indicating communication between a server node and a server node, “communication between server node and the Internet” indicating communication between a server node and another server connected to the Internet, “communication between server node and security node” indicating communication between a server node and a security node, and “communication between server node and storage device” indicating communication between a server node and a storage device. The network service identifier 405 is information indicating the type of network service for which the communication is used. The network service identifier 405 includes, for example, “HTTP” indicating data communication according to HTTP, “HTTPS” indicating encrypted data exchange according to HTTP, and “SQL” indicating access to a database.

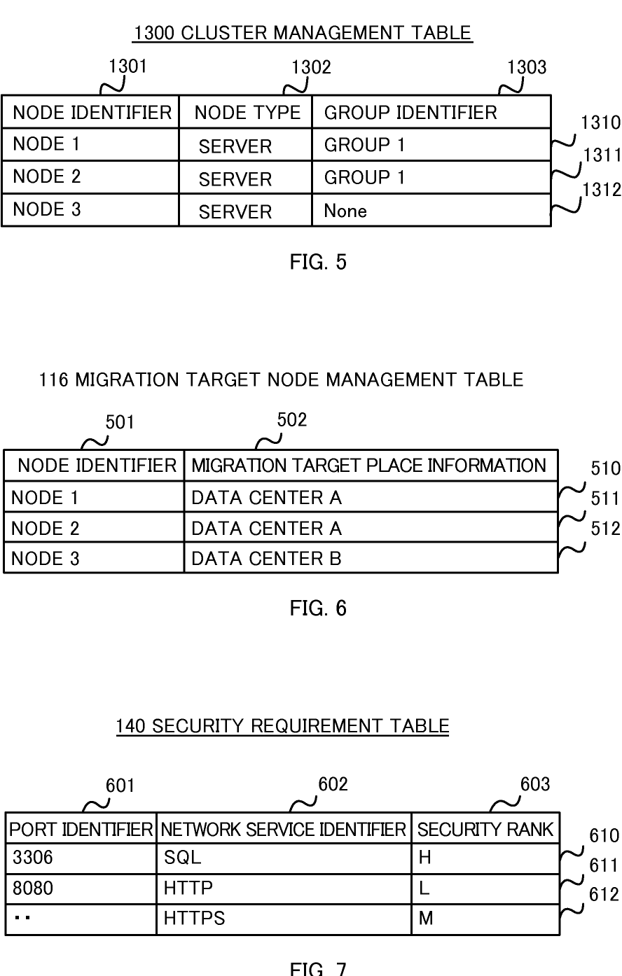

FIG. 5 is a diagram showing a configuration example of a cluster management table 1300 which may be included in the node properties 203 to manage properties regarding availability. The cluster management table 1300 is for managing nodes having a redundant cluster configuration in the migration source information processing system 101 to improve availability. Each redundant cluster is uniquely identified by a group identifier 1303. For example, when a node 1 and a node 2 are grouped into a redundant cluster, “group 1” is set to each of them, as shown in FIG. 5.

The migration target node management table 116 is for managing each to-be-migrated node of the migration source information processing system 101 and place information indicating the place to which the node is to be migrated. The migration target node management table 116 is updated by the migration request receiver 110, and is referred to by the tenant design property generator 111.

FIG. 6 is a configuration example of the migration target node management table 116. The migration target node management table 116 is created by the migration request receiver 110 upon receipt of a migration request from the client terminal 103, and is referred to by the tenant design property generator 111. The migration target node management table 116 associates a node identifier 501 indicating a node to be migrated and migration target place information 502 with each other. The migration target place information 502 includes, but is not limited to, a data center to which the node is migrated. For example, the migration target place information 502 may be an address such as a prefecture, position information such as latitude and longitude, or a network address identifying a network where the node is to be placed. In the embodiment, records for all the nodes to be migrated are registered in the migration target node management table 116. For example, in a case of migrating all the nodes of the migration source information processing system 101, identifiers of all the nodes and migration target place information on those nodes are registered in the migration target node management table 116. In a case of migrating only some of the nodes of the migration source information processing system, only identifiers of nodes to be migrated and migration target place information on those nodes are registered in the migration target node management table 116. Nodes to be migrated and their migration targets are inputted from the client terminal 103 via a GUI, are contained in a migration request, and are transmitted from the client terminal 103 to the tenant design management system 100.

The design requirement management table 117 is a table for managing non-functional design requirements for the migration target information processing system 102. The design requirement management table 117 includes a security requirement table 140, a performance requirement table 141, and a node configuration modification rule management table 142. In addition to these, the design requirement management table 117 may include an availability requirement table 1400 and the like (not shown).

FIG. 7 is a configuration example of the security requirement table 140. The security requirement table 140 stores requirements regarding communication security (called “security requirements” hereinbelow). The security requirement table 140 is for managing a port identifier 601 indicating a port used for communication, a network service identifier 602 indicating the type of a network service for which the communication is used, and a security rank 603 indicating the level of security, in association with one another. The security requirement table 140 is created in advance and modified by the system property registration unit 113, and is referred to by the tenant design property generator 111. In the embodiment, three ranks, namely H (high), M (medium), and L (low), are set as the security rank 603, and the communication of the rank H is treated as having the highest security level.

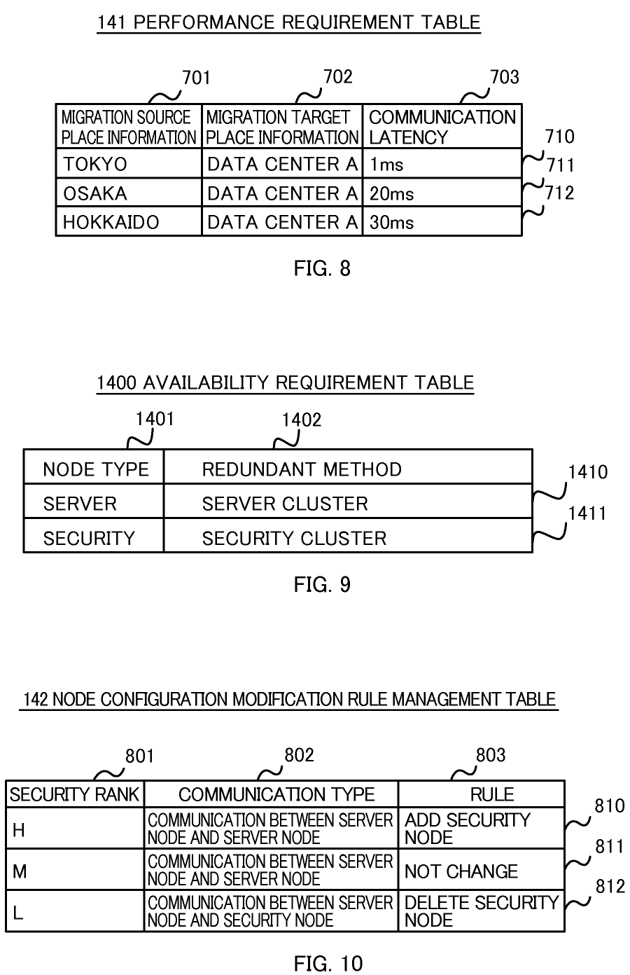

FIG. 8 is a configuration example of the performance requirement table 141. The performance requirement table 141 is for managing requirements regarding communication performance (called “performance requirements” below). The performance requirement table 141 is for managing communication delay (latency) between a source and a destination. The performance requirement table 141 is created by the system property registration unit 113 in advance, and is modified when necessary. The performance requirement table 141 is referred to by the tenant design property generator 111. The performance requirement table 141 stores migration source place information 701, migration target place information 702, and communication latency 703 in association with one another. When there are multiple communication channels of different latencies between the source and the target, the performance requirement table 141 may further associate and store communication channel information.

FIG. 9 is a configuration example of the availability requirement table 1400 which may be included in the design requirement management table 117. The availability requirement table 1400 is for managing requirements regarding availability (called “availability requirements” hereinbelow). The availability requirement table 1400 stores a node type 1401 and a redundancy method 1402 in association with each other. For example, in a case where the node type 1401 is a “server,” server clustering is performed. In a case where the node type is “security,” security clustering is performed. The clustering can be performed using known techniques, and is therefore not described herein. To change the availability requirement between the migration source and the migration target, for example, information indicating that the availability is to be maintained (“Maintain”), enhanced (“Enhance”), or simplified (“Simplify”) is added to the migration request. Of course, irrespective of the migration request, the migration target may automatically decide the availability requirement according to the design policies thereof.

FIG. 10 is a configuration example of the node configuration modification rule management table 142. The node configuration modification rule management table 142 is for managing rules for determining whether or not to modify the configuration of a node in the migration target information processing system 102. The node configuration modification rule management table 142 is created by the system property registration unit 113 in advance, and is modified when necessary. The node configuration modification rule management table 142 is referred to by the tenant design property generator 111. The node configuration modification rule management table 142 stores a rule 803 in association with a security rank 801 and a communication type 802. The security rank 801 is the same as the security rank 603 in the security requirement table 140. The communication type 802 is the same as the communication type 404 in the communication property management table 202. In the rule 803, whether a node configuration needs to be modified or not is recorded.

For example, in a record 810, the rule 803 defines that adding a security node to the tenant design properties (“Add security node”) is necessary when the security rank 801 is “H” and the communication type 802 is “communication between server node and server node.” This indicates that, when the level of security is high, migration requires modification of a node configuration for communication between server nodes so that the communication is performed via a security node, such as a firewall, in the migration target information processing system 102. In a record 812, the rule 803 defines that deleting a security node (“Delete security node”) is necessary when the security rank 801 is “L” and the communication type 802 is “communication between server node and security node.” This indicates that even when the communication has been performed via a security node in the migration source information processing system 101, if the security level is low, migration requires modification of a node configuration so that the communication may not be performed via a security node in the migration target information processing system 102. It should be noted that the rules registered in the node configuration modification rule management table 142 are not limited to those described in FIG. 10.

For example, a node configuration modification rule according to the availability requirement is also registered in the node configuration modification rule management table 142. In this case, a new node is added to a target group when the availability requirement contained in the migration request is “Enhance,” and a node is deleted from the target group when the availability requirement is “Simplify.” The node configuration is not modified when the availability requirement indicates “Maintain.”

The tenant design property management table 118 is for managing design information (called “tenant design properties” hereinbelow) necessary for migrating the migration source information processing system 101 to the migration target information processing system 102. The format of the tenant design properties managed by the tenant design property management table 118 is the same as that of the system properties managed by the system property management table 115. The contents of the tenant design properties can change depending on the node configuration, and the node properties can change depending on the design requirements of the migration target information processing system 102.

The migration request receiver 110 receives a migration request from the management I/F 106 of the client terminal 103, and analyzes the request. The migration request receiver 110 includes a GUI display unit 120, a request analysis unit 121, a table registration unit 122, and a portal caller 123. Besides the migration request, the migration request receiver 110 also receives a request to perform analysis for registering system properties, a requirement registration request for registering information in the design requirement management table 117, a system construction request for constructing a migration target information processing system, and the like. The requests, however, are not limited to those given above.

The GUI display unit 120 provides graphical user interface to the client terminal 103. The GUI display unit 120 is capable of providing user interface by sending the client terminal 103 viewer data described for example in HTML.

The request analysis unit 121 analyzes a request received from the client terminal 103, and inputs analysis results to the tenant design property generator 111. The request is for example an HTTP request. When the request is a migration request, the request contains a node to be migrated and its migration target place information, for example. The migration request may also contain system properties inputted by the user.

If the request is a migration request, the table registration unit 122 registers a node to be migrated and its migration target place information in the migration target node management table 116.

The portal caller 123 performs automatic design of the migration target information processing system 102 when a request inputted from the client terminal 103 and analyzed is a request to configure the migration target information processing system 102. The portal caller 123 calls the service portal 180 in the manager 170 of the migration target information processing system 102 by giving the tenant design property management table 118 to the service portal 180, and thereby enables automatic system design to be performed in the migration target information processing system 102. For the automatic system design processing, general design processing for a cloud system can be used.

The tenant design property generator 111 generates the tenant design property management table 118. The tenant design property generator 111 includes an identifier 130, a comparator 131, a mapper 132, and a generator 133.

The identifier 130 identifies a communication flow involving a node to be migrated. In the communication property management table 202, the identifier 130 identifies the communication flow identifier 401, the communication type 404, and the network service identifier 405 associated with the source 402 or destination 403 registered as the node identifier 501 in the migration target node management table 116.

The comparator 131 identifies a security rank and communication latency of the communication flow. In the security requirement table 140, the comparator 131 identifies the security rank 603 associated with the network service identifier 405 identified by the identifier 130.

The mapper 132 determines whether addition or deletion of a security node is necessary or not. In the node configuration modification rule management table 142, the mapper 132 identifies the rule 803 associated with the security rank 603 identified by the comparator 131 and the communication type 404 identified by the identifier 130.

The generator 133 generates tenant design properties based on system properties. If the mapper 132 judges that addition or deletion of a security node is necessary, the generator 133 generates the tenant design properties which are modified by adding or deleting a security node. In the embodiment, the generator 133 corrects system properties registered in the system property management table 115 and then registers the corrected system properties in the tenant design property management table 118 as the tenant design properties.

The system property registration unit 113 generates the system property management table 115 when the request received from the client terminal 103 is a migration request. Known processing can be used for processing performed by the system property registration unit 113 to collect the system properties of the migration source information processing system 101. When the migration request contains system properties, the system property registration unit 113 may registers the system properties contained in the migration request, in the system property management table 115.

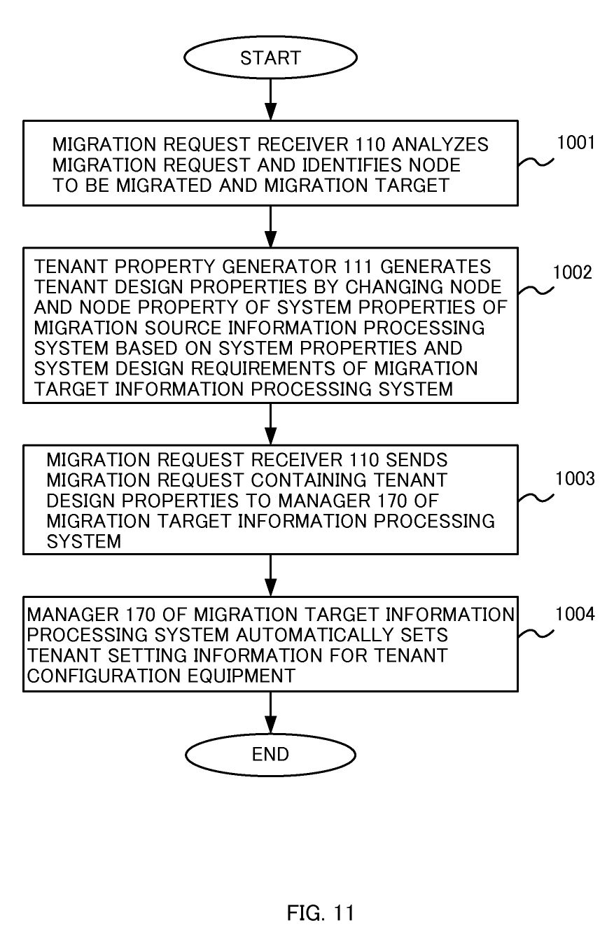

FIG. 11 is a diagram showing an overall processing flow performed by the tenant design management system 100 to migrate the migration source information processing system 101 to the migration target information processing system 102, according to the present invention.

The migration request receiver 110 of the tenant design management system 100 receives a migration request from the client terminal 103, analyzes the migration request, and identifies a node to be migrated and a migration target (S1001).

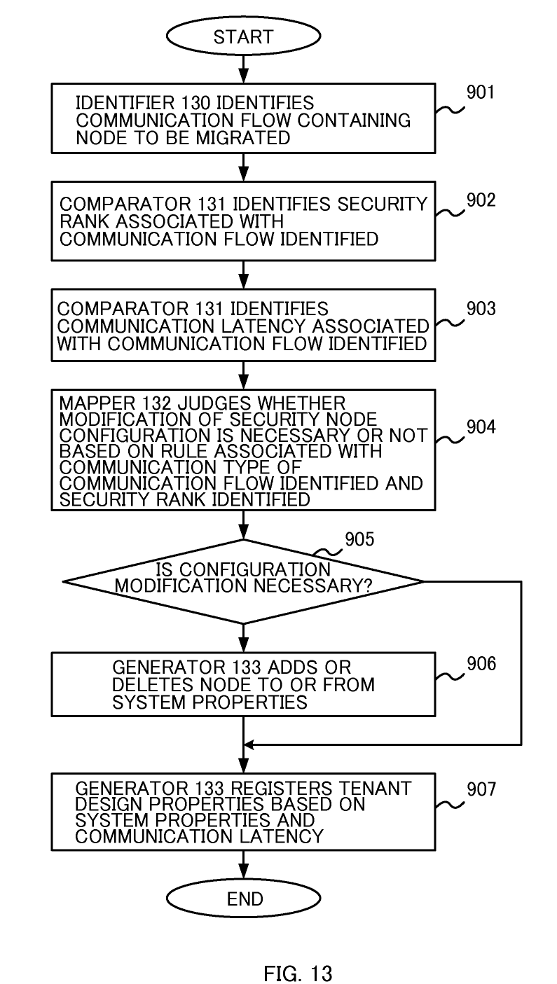

Next, the tenant design property generator 111 of the tenant design management system 100 creates tenant design properties by changing a node configuration and node properties based on system properties of the migration source information processing system 101 and design requirements of the migration target information processing system 102 (S1002). Details of this step will be described later with reference to FIG. 13.

The migration request receiver 110 of the tenant design management system 100 calls the service portal 180 of the migration target information processing system 102 by sending the manager 170 a tenant configuration request along with the tenant design properties created above, the tenant configuration request requesting to perform automatic design to create the tenant setting information 182 (S1003).

The service portal 180 of the manager 170 of the migration target information processing system 102 calls the automatic designer 181 upon receipt of the tenant configuration request from the tenant design management system 100, and the automatic designer 181 generates the tenant setting information 182 based on the tenant design properties and resource usage information and sets them to setting target equipment (S1004). The processing in Steps S1003 and S1004 can be implemented by a method disclosed for example in Japanese Patent Application Publication No. 2012-253550.

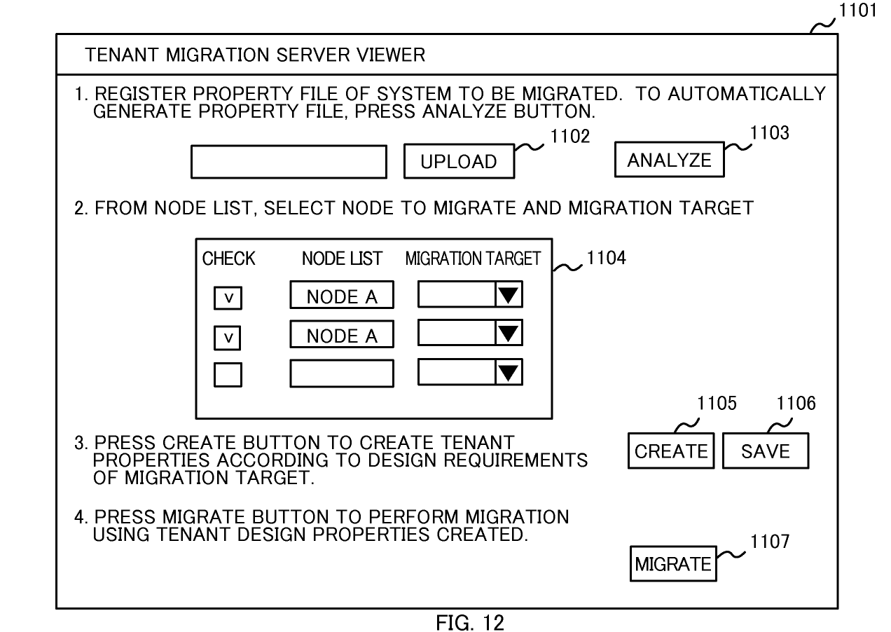

FIG. 12 is an image of a viewer for providing a tenant migration service according to the present invention.

First, a user registers system properties of a migration source information processing system. The user may register system properties created in advance (1102), or may cause the system properties to be created automatically. An Analyze button (1103) is used to automatically create the system properties.

Next, the user designates a node to be migrated by use of a node list for the system properties registered (1104). For example, from a list of nodes for the system properties displayed, the user selects a node to be migrated by means of a check box or the like. A migration target is selected as well by means of, for example, a pull-down menu. Migration targets are registered in advance by a migration service provider.

Pressing a Create button (1105) after the selection is made creates the tenant design properties. When it is successful, a Save button (1106) is activated to allow saving and reference of the tenant design properties of the migration target.

Finally, to execute migration using the tenant design properties, a Migrate button (1106) is pressed. When it is successful, a viewer indicating the success is displayed.

FIG. 13 is a diagram showing a processing flow performed by the tenant design property generator 111.

The identifier 130 identifies a communication flow involving a node to be migrated (S901). In the embodiment, the identifier 130 uses the system property management table 115. Specifically, in response to a migration request, the identifier 130 determines whether the node identifier 501 registered in the migration target node management table 116 coincides with the source or destination of any communication property managed in the communication property management table 202 or not, and identifies the communication property whose source or destination coincides with the node identifier 501, as a communication property for the communication flow involving the node to be migrated. The identifier 130 may identify the communication property by directly analyzing the migration request. Specifically, the migration request may contain a node identifier of the node to be migrated and its migration target place information, and the identifier 130 may extract the node identifier and the migration target place information contained in the migration request.

The comparator 131 identifies the security rank of a network service used by the communication flow identified (S902). Specifically, in the security requirement table 140, the comparator 131 identifies the security rank 603 associated with the network service identifier 602 which coincides with the network service identifier 405 contained in the communication property registered in the communication property management table 202. When there is more than one security rank 603, e.g., in a case where more than one network service is used by the communication flow, the comparator 131 identifies the highest security rank as the security rank of the communication flow.

The comparator 131 identifies communication latency between source place information and destination place information of the communication flow (S903). Specifically, assuming that the installation place of each node is known, when the migration target place information 502 for the source 402 of the communication property identified is registered in the migration target node management table 116, the comparator 131 reads the migration target place information 502 from the migration target node management table 116, and when it is not registered, the comparator 131 identifies the installed place of the source 402. Similarly, when the migration target place information 502 for the destination 403 of the communication property identified is registered in the migration target node management table 116, the comparator 131 reads the migration target place information 502 from the migration target node management table 116, and when it is not registered, the comparator 131 identifies the installed place of the destination 403. In the performance requirement table 141, the comparator 131 identifies the communication latency 703 associated with the place of the source 402 and the place of the destination 403.

Next, the mapper 132 judges whether the communication flow identified needs node configuration modification or not (S904). Specifically, the mapper 132 searches the node configuration modification rule management table 142 for the rule 803 associated with the communication type 404 of the communication property identified in Step S901 and the security rank 603 identified in Step S902, and determines based on the rule 803 thus found whether addition or deletion of a security node is necessary or not. For instance, when the security rank 603 is “H” and the communication type 404 of the communication flow of the system properties is “communication between server node and server node,” the rule 803 identified in the node configuration modification rule management table 142 shown in FIG. 10 indicates “Add security node.” Thus, the mapper 132 determines that a security node needs to be added between the server node and the server node.

When the mapper 132 determines that the node configuration modification is necessary (S905: YES), the generator 133 adds a security node to the node configuration of the system properties or deletes a security node from the node configuration of the system properties (S906). Specifically, the generator 133 adds or deletes a record for the node to or from the node property management table 201. When the mapper 132 determines that the node configuration modification is unnecessary (S905: NO), the node configuration is not modified.

The generator 133 creates tenant design properties based on the system properties and the communication latency and registers the tenant design properties in the tenant design property management table 118 (S907). The generator 133 generates the tenant design properties based on the system properties managed by the system property management table 115. For example, the generator 133 can change a timeout value in the performance property of the node according to the communication latency identified. Further, when a security node is added, the generator 133 changes communication properties regarding the added security node (such as, e.g., source and destination correspondence and the communication type).

FIG. 14B illustrates the tenant design properties for the migration target information processing system 102. When a determination is made that addition of a security node is necessary, a security node 1201 is added, a node property 1202 related to the added node 1201 is generated, and node properties 1203, 1204, and 1205 containing time-out periods and the like which need to be modified for the migration are modified.

According to the migration assist system of the embodiment, tenant design properties for the migration target information processing system 102 having different design requirements from those of the migration source information processing system 101 can be automatically created from the system properties of the migration source information processing system 101. As a result, costs for migration work can be reduced.

Moreover, according to the migration assist system of the embodiment, node configurations for the migration target information processing system 102 can be changed by determining addition or deletion of a node according to non-functional design requirements managed by the design requirement management table 117. Thus, in migration of an information processing system, a necessary node can be increased and an unnecessary node can be decreased, enabling efficient operation of the migration target information processing system 102.

Further, according to the migration assist system of the embodiment, the tenant design information for the migration target can be automatically created by associating with each other the communication information on the existing migration source information processing system 101 and design requirements of the migration target. Thus, design errors by a system designer can be reduced.

In addition, according to the migration assist system of the embodiment, for a communication flow having a high security rank, a security node such as a firewall can be added to the node configuration of the migration target information processing system 102 so that the communication can be performed via the security node. Hence, when security measures become necessary as a result of migration, e.g., when an intracompany system is migrated to a cloud, the migration target information processing system 102 can be set up with a security node being automatically added. This prevents a situation where the migration leads to vulnerability.

Further, according to the migration assist system of the embodiment, in a case where communication is performed via a security node in a communication flow having a low security rank, the security node can be deleted from the node configuration of the migration target information processing system 102 so that communication may be performed not via the security node in the migration target information processing system 102. Hence, an unnecessary security node can be deleted to improve communication efficiency, allowing improvement in overall processing efficiency of the migration target information processing system 102.

Further, tenant design properties can be generated based on communication latency managed according to the migration target place information on a node to be migrated. Thus, communication latency after migration of the migration source information processing system 101 to the migration target information processing system 102 can be assumed in advance. This allows reduction in problems occurring during tests for communication delay and also reduction in man-hours for work such as performance tuning.

The embodiment assumes that system properties of the migration source information processing system 101 are registered in the system property management table 115 in advance, but the system properties of the migration source information processing system 101 may be generated automatically. In this case, the tenant design management system 100 includes a system property analyzer in addition to the constituents described earlier. Upon receipt of a system property analysis request from the client terminal 103, the system property analyzer accesses nodes to be analyzed of the existing information processing system, which are contained in the analysis request, to acquire the properties of each node and communication properties. The nodes to be analyzed can be identified by, for example, prompting the user to specify, on the client terminal 103, IP addresses. The system property analyzer can acquire the node properties by reading hardware and software configuration information. The system property analyzer can acquire the communication properties by, for example, collecting traffic information by capturing communication packets between the target nodes and analyzing the traffic information. Any of various known approaches can be used to collect the traffic information. The system property analyzer passes analysis results to the system property registration unit 113. The system property registration unit 113 registers the analysis results in the system property management table 115. In order for the system property analyzer to capture communication by the migration source information processing system 101, it is desirable that the tenant design management system 100 be connected to an internal network of the migration source information processing system 101. It should be noted that this does not apply when an approach other than capturing is used. By the configuration above, without the system properties registered from the client terminal 103, the tenant design management system 100 can automatically access each node of the existing migration source information processing system 101 to collect and analyze setting information. Thus, trouble for inputting the system properties can be reduced.

By the descriptions herein, at least the following are shown.

Specifically, in a migration assist system of the present invention, the communication information contains a source node identifier indicating the first node of a data transmission source, a destination node identifier indicating the first node of a data transmission destination, and a network service identifier indicating a network service used for the communication. The design requirement management table includes a security requirement table managing a security rank in association with the network service identifier, the security rank indicating a level of security necessary for the communication, and a node configuration modification rule management table storing a rule in association with the security rank, the rule indicating whether addition or deletion of the second node is necessary or not. the comparator acquires the security rank associated the network service identifier contained in the communication information from the security requirement table, and acquires the rule associated with the security rank from the node configuration modification rule management table, and the mapper judges based on the rule whether the addition or deletion of the second node is necessary or not. In addition, in a migration assist method, the communication information contains a source node identifier indicating the first node of a data transmission source, a destination node identifier indicating the first node of a data transmission destination, and a network service identifier indicating a network service used for the communication. The design requirement management table includes a security requirement table managing a security rank in association with the network service identifier, the security rank indicating a level of security necessary for the communication, and a node configuration modification rule management table storing a rule in association with the security rank, the rule indicating whether addition or deletion of the second node is necessary or not. In the step of acquiring the design requirement, the information processing apparatus acquires the security rank associated with the network service identifier contained in the communication information from the security requirement table, and acquires the rule associated with the security rank from the node configuration modification rule management table, and in the step of judging whether addition or deletion of the second node is necessary or not, the information processing apparatus judges based on the rule whether the addition or deletion of the second node is necessary or not.

According to such a configuration, whether addition or deletion of a node is necessary or not can be judged based on the communication security rank. Thus, measures can be taken such as e.g. adding a security node when the security rank is high and deleting a security node when the security rank is low. Hence, node configurations can be flexibly modified according to a security level necessary after migration.

Moreover, in the migration assist system of the present invention, the communication information further includes a communication type, and the node configuration modification rule management table stores the rule in association with the communication type and the security rank. The comparator acquires the rule associated with the security rank and the communication type which is contained in the communication information. In addition, in the migration assist method of the present invention, the communication information further includes a communication type, and the node configuration modification rule management table stores the rule in association with the communication type and the security rank. In the step of acquiring the design requirement, the information processing apparatus acquires the rule associated with the security rank and the communication type which is contained in the communication information.

According to such a configuration, whether the addition or deletion of a node is necessary or not can be judged based not only on the security rank, but also on the communication type. Thus, by causing the communication type to indicate the kind of communication performed between nodes, the necessity of node addition or deletion can be securely and readily determined. For instance, when the communication type indicates that communication is performed via a security node and the security level is high, a determination is made that a security node is not added additionally. Thus, unnecessary addition of a node can be prevented.

Moreover, in the migration assist system of the present invention, the identifier receives a migration request containing an identifier of the first node to be migrated, and identifies the communication information involving the first node indicated by the identifier contained in the migration request. According to such a configuration, migration can be performed in accordance with a migration request transmitted from the client terminal 103 or the like. This means that the configuration and the like of the first information processing system do not need to be managed in advance, so that resources necessary for assisting migration can be reduced.

Moreover, in the migration assist system of the present invention, the migration request contains migration target place information for the first node to be migrated, and the design requirement management table includes a performance requirement table managing place information on the second node of a data transmission source, place information on the second node of a data transmission destination, and a communication delay period by associating them with one another. The generator acquires the communication delay period associated with the source place information and the destination place information from the performance requirement table, and generates the tenant design properties while including setting for the second node in accordance with the communication delay period acquired. According to such a configuration, the second node can be set according to a communication delay period for the migration target of the node. For example, a timeout period of the second node can be set according to the communication delay period. Thus, an appropriate timeout period can be set to avoid a situation where timeout of the second node frequently occurs because the communication delay period is prolonged as a result of migration of the information processing system.

Moreover, in the migration assist system of the present invention, the second information processing system includes a manager configured to set up the second information processing system based on the tenant design properties, and the migration assist system further comprises a caller configured to send the manager a setting request containing the tenant design properties. According to such a configuration, the second information processing system can be set up automatically. Thus, the trouble required for migration of an information processing system can be further diminished.

Moreover, in the migration assist system of the present invention, the migration assist system further comprises a system property management table storing system properties indicating settings of the first information processing system. The system properties include a network policy for setting up a network in the first information processing system, and the generator modifies the system properties according to whether the addition or deletion is necessary or not, and thereby generates the tenant design properties. According to such a configuration, the second information processing system can be set up by adding modifications necessary for migration to the settings of the first information processing system. Thus, the information processing system can be migrated by adding as less modifications as possible and adding only necessary modifications.

Although the present invention has been described using the embodiment given above, the embodiment is provided only to facilitate an understanding of the present invention, and is not intended to give limitative interpretation of the present invention. The present invention can be modified and improved without departing from the gist thereof, and includes such equivalents.

What is claimed is:

1. A system for assisting migration from a first information processing system to a second information processing system, the migration assist system comprising:
a communication information management table retaining communication information on communication between first nodes constituting the first information processing system;
a design requirement management table retaining a design requirement being a condition for a second node constituting the second information processing system;
an identifier configured to identify, in the communication information management table, the communication information on the first node which is to be migrated;
a comparator configured to acquire the design requirement associated with the identified communication information from the design requirement management table;
a mapper configured to determine based on the design requirement whether addition or deletion of the second node is necessary or not; and
a generator configured to generate tenant design properties based on the determination on whether addition or deletion is necessary or not, the tenant design properties being information necessary for the migration and containing a configuration of the second node constituting the second information processing system.

2. The migration assist system according to claim 1, wherein
the communication information contains a source node identifier indicating the first node of a data transmission source, a destination node identifier indicating the first node of a data transmission destination, and a network service identifier indicating a network service used for the communication,
the design requirement management table includes
a security requirement table managing a security rank in association with the network service identifier, the security rank indicating a level of security necessary for the communication, and
a node configuration modification rule management table storing a rule in association with the security rank, the rule indicating whether addition or deletion of the second node is necessary or not,
the comparator acquires the security rank associated with the network service identifier contained in the communication information from the security requirement table, and acquires the rule associated with the security rank from the node configuration modification rule management table, and
the mapper judges based on the rule whether the addition or deletion of the second node is necessary or not.

3. The migration assist system according to claim 2, wherein
the communication information further includes a communication type,
the node configuration modification rule management table stores the rule in association with the communication type and the security rank, and
the comparator acquires the rule associated with the security rank and the communication type which is contained in the communication information.

4. The migration assist system according to claim 1, wherein
the identifier receives a migration request containing an identifier of the first node to be migrated, and identifies the communication information involving the first node indicated by the identifier contained in the migration request.

5. The migration assist system according to claim 4, wherein
the migration request contains migration target place information for the first node to be migrated,
the design requirement management table includes a performance requirement table managing place information on the second node of a data transmission source, place information on the second node of a data transmission destination, and a communication delay period by associating them with one another, and
the generator acquires the communication delay period associated with the source place information and the destination place information from the performance requirement table, and generates the tenant design properties while including setting for the second node in accordance with the communication delay period acquired.

6. The migration assist system according to claim 1, wherein
the second information processing system includes a manager configured to set up the second information processing system based on the tenant design properties, and
the migration assist system further comprises a caller configured to send the manager a setting request containing the tenant design properties.

7. The migration assist system according to claim 1, wherein
the migration assist system further comprises a system property management table storing system properties indicating settings of the first information processing system,
the system properties include a network policy for setting up a network in the first information processing system, and
the generator modifies the system properties according to whether the addition or deletion is necessary or not, and thereby generates the tenant design properties.

8. A method for an information processing apparatus to assist migration from a first information processing system to a second information processing system, the information processing apparatus including a communication information management table retaining communication information on communication between first nodes constituting the first information processing system, and a design requirement management table retaining a design requirement being a condition for second node constituting the second information processing system,
the method comprising the steps, executed by the information processing apparatus, of:
identifying, in the communication information management table, the communication information on the first node which is to be migrated;
acquiring the design requirement associated with the identified communication information from the design requirement management table;
determining based on the design requirement whether addition or deletion of the second node is necessary or not; and
generating tenant design properties based on the determination on whether addition or deletion is necessary or not, the tenant design properties being information necessary for the migration and containing a configuration of the second node constituting the second information processing system.

9. The migration assist method according to claim 8, wherein
the communication information contains a source node identifier indicating the first node of a data transmission source, a destination node identifier indicating the first node of a data transmission destination, and a network service identifier indicating a network service used for the communication,
the design requirement management table includes
a security requirement table managing a security rank in association with the network service identifier, the security rank indicating a level of security necessary for the communication, and
a node configuration modification rule management table storing a rule in association with the security rank, the rule indicating whether addition or deletion of the second node is necessary or not,
in the step of acquiring the design requirement, the information processing apparatus acquires the security rank associated with the network service identifier contained in the communication information from the security requirement table, and acquires the rule associated with the security rank from the node configuration modification rule management table, and
in the step of judging whether addition or deletion of the second node is necessary or not, the information processing apparatus judges based on the rule whether the addition or deletion of the second node is necessary or not.

10. The migration assist method according to claim 9, wherein
the communication information further includes a communication type,
the node configuration modification rule management table stores the rule in association with the communication type and the security rank, and
in the step of acquiring the design requirement, the information processing apparatus acquires the rule associated with the security rank and the communication type which is contained in the communication information.

11. A system for assisting migration from a first information processing system to a second information processing system, the migration assist system comprising:
a first table retaining IDs of components constituting the first information processing system, information on connections between the components, and property settings for the connections;
a second table retaining non-functional requirements for the property settings, and rules to modify the information on the connections to satisfy the requirements; and
a generator configured to identify one of the rules for each of the components based on the first and second tables, apply the rule to information extracted from the first table, and generate design information to build the second information processing system.
